(19) United States
(12) Patent Application Publication
(10) Pub. No.: US 2013/0132368 A1
(43) Pub. Date: May 23, 2013

(54) LARGE SCALE ANALYTICAL REPORTING FROM WEB CONTENT

(71) Applicant: Wolfram Alpha, LLC, Champaign, IL (US)

(72) Inventor: Stephen Wolfram, Champaign, IL (US)

(73) Assignee: WOLFRAM ALPHA, LLC, Champaign, IL (US)

(21) Appl. No.: 13/669,203

(22) Filed: Nov. 5, 2012

Related U.S. Application Data
(60) Provisional application No. 61/556,173, filed on Nov. 4, 2011.

(51) Int. Cl. G06F 17/30

(52) U.S. Cl. CPC G06F 17/30864
USPC 707/711

(57) ABSTRACT

An analysis system is configured to perform quantitative (e.g., statistical) and/or qualitative analysis of large numbers of documents, files, etc., such as web pages, images on web pages, social medial pages, or other documents available via the Internet, an extranet, an Intranet, etc. In some embodiments, the large numbers of documents, files, etc., may be treated as a data set that can be quantitatively analyzed and reports of such analyses may be made electronically available to a user.

### CROSS-REFERENCE TO RELATED APPLICATION

The present application claims the benefit of U.S. Provisional Application No. 61/556,173, filed on Nov. 4, 2011, entitled “Large Scale Analytical Reporting from Web Content,” which is hereby incorporated by reference herein in its entirety.

### FIELD OF TECHNOLOGY

The present disclosure generally relates to systems that enable analysis of information contained in large numbers of documents or files, such as web pages, blogs, social media pages, etc.

### BACKGROUND

Internet search engines allow searching for web pages that include particular terms. Typically, a web crawler application automatically retrieves web pages from the World Wide Web, and the retrieved web pages are analyzed. For example, titles, headings, other words within the web page, and metatags may be analyzed to determine how web pages should be indexed in an index maintained by the search engine. A copy of the each retrieved web page may also be stored (i.e., cached). When a user enters search terms into the search engine, the search engine examines the index based on the search terms and returns a listing of web pages that the search engine determines best match the search terms.

### SUMMARY

An analysis system is configured to perform, and/or a method of analysis includes, quantitative (e.g., statistical) and/or qualitative analysis of large numbers of documents, files, etc., such as web pages, images on web pages, social medial pages, or other documents available via the Internet, an extranet, an Intranet, etc. In some embodiments, the large numbers of documents, files, etc., may be treated as a data set that can be quantitatively analyzed and reports of such analyses may be made electronically available to a user. In some embodiments, at least some analyses may be performed in advance to anticipate analyses that users may request. Additionally or alternatively, data generated from previous analyses may be stored for use in future analyses. Additionally or alternatively, analyses may be performed in response to user requests.

In one embodiment, a method for quantitatively and/or qualitatively analyzing a plurality of documents available on a communication network includes generating, at one or more computing devices, inferred metadata regarding documents in the plurality of documents available on the communication network at least by (i) using a search engine index that indexes the plurality documents, and (ii) analyzing one or more of (a) contents of documents in the plurality of documents, (b) metadata included in documents in the plurality of documents, (c) data associated with documents in the plurality of documents and external to the documents, (d) previously generated inferred metadata regarding documents in the plurality of documents. The method also includes responsive to a request to perform a quantitative and/or qualitative analysis of the plurality of documents, performing, at one or more computing devices, the requested analysis using (i) the search engine index, and (ii) the inferred metadata. Additionally, the method includes generating, at one or more computing devices, a report that includes results of the requested analysis.

In another embodiment, a system for quantitatively and/or qualitatively analyzing a plurality of documents available on a communication network comprises one or more computing devices configured to generate inferred metadata regarding documents in the plurality of documents available on the communication network at least by (i) using a search engine index that indexes the plurality documents, and (ii) analyzing one or more of (a) contents of documents in the plurality of documents, (b) metadata included in documents in the plurality of documents, (c) data associated with documents in the plurality of documents and external to the documents, (d) previously generated inferred metadata regarding documents in the plurality of documents. The one or more computing devices are also configured to perform, responsive to a request to perform a quantitative and/or qualitative analysis of the plurality of documents, the requested analysis using (i) the search engine index, and (ii) the inferred metadata. The one or more computing devices are further configured to generate a report that includes results of the requested analysis.

In yet another embodiment, a tangible, non-transitory, computer readable medium stores machine readable instructions that, when executed by one or more computing devices, cause the one or more computing devices to generate inferred metadata regarding documents in the plurality of documents available on the communication network at least by (i) using a search engine index that indexes the plurality documents, and (ii) analyzing one or more of (a) contents of documents in the plurality of documents, (b) metadata included in documents in the plurality of documents, (c) data associated with documents in the plurality of documents and external to the documents, (d) previously generated inferred metadata regarding documents in the plurality of documents; responsive to a request to perform a quantitative and/or qualitative analysis of the plurality of documents, perform the requested analysis using (i) the search engine index, and (ii) the inferred metadata; and generate a report that includes results of the requested analysis.

### BRIEF DESCRIPTION OF THE DRAWINGS

FIG. 1 is a diagram of an example system in which a large number of documents or files (e.g., web pages, social media pages, etc.) are analyzed to provide quantitative and/or qualitative information regarding information stored in or related to the documents, files, etc., according to an embodiment.

FIG. 2 is a diagram of an example analysis system that may be utilized in the system of FIG. 1, according to an embodiment.

FIG. 3 is a diagram of an example method that may be implemented by the system of FIG. 1 and/or the analysis system of FIG. 2.

### DETAILED DESCRIPTION

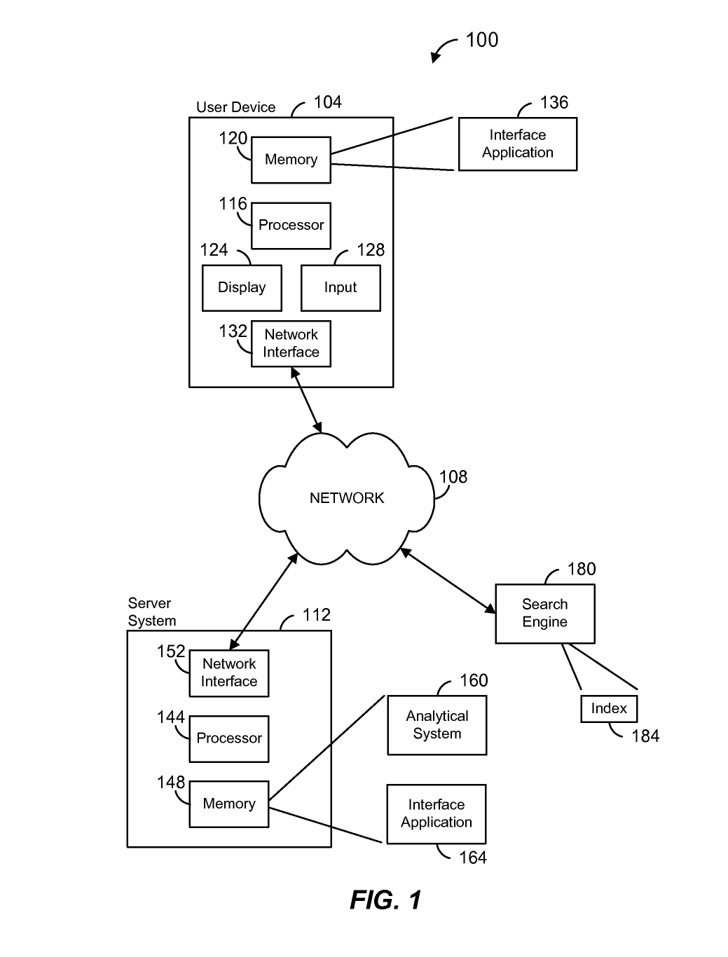

FIG. 1 is a diagram of an example system 100 in which a large number of documents or files (e.g., web pages, social media pages, etc.) are analyzed to provide quantitative and/or qualitative information regarding information stored in or related to the documents, files, etc., according to an embodiment. A user device 104 is communicatively coupled to a communication network 108 that may include the Internet, and/or other types of networks such as an intranet, an extranet, etc. A server system 112 is also communicatively coupled to the network 108. The network 108 may include or be coupled to a large number of computing systems (e.g., computers, servers, etc.) that make a large number of documents, files, etc., (e.g., web pages, blogs, social media pages, etc.) electronically accessible via the network 108.

The user computer 104 is configured to communicate with the server system 112 via the network 108. In particular, the user computer 104 may be configured to transmit electronically to the server system 112, via the network 108, a user input that indicates a request for an analysis of documents, files, etc., accessible via the network 108.

The server system 112 may be configured to analyze documents, files, etc., accessible via the network 108, and to provide such analyses to requesting devices, such as the user computer 104, via the network. The server system 112 may be configured to receive electronically, via the network 108, a request for an analysis from the user computer 104, and to perform the requested analysis in response to the request.

In some embodiments, the user computer 104 and the server system 112 may communicate via a network or communication link separate from the network 108.

The user computer 104 may be a computing device such as a desktop computer, a gaming system, a tablet computer, a smart phone, etc. The user computer 104 may include one or more processors 116, one more memory devices 120 (e.g., random access memory (RAM), read only memory (ROM), FLASH memory, a magnetic disk, an optical disk, etc.), one or more display devices 124 (e.g., integral display device and/or external display device), and one or more input devices, such as a keyboard, a keypad, a button, a mouse, a trackball, a touch screen, a multi-touch screen, a touch pad, etc. The user computer 104 may include a network interface 132 to communicatively couple the user computer 104 to the network 108 (or another suitable network or communication link for communicating with the server system 112). At least some of the one or more processors 116, the one or more memory devices 120, the one or more display devices 124, the one or more input devices 128, and the network interface 132 may be communicatively coupled together via one or more of 1) one or more busses, 2) cords, etc. (not shown).

The one or more memory devices 120 may store a suitable user interface application 136, such as a web browser application, for exchanging information with the server system 112. The user interface application 136, when executed by the one or more processors 120, may enable a user to enter an indication of an analysis to be performed by the server system 112. For example, a web browser application may permit a user to enter text in a text box, make selections using menus, buttons, etc., on a web page generated by the server system 112. Additionally or alternatively, the user interface application 136, when executed by the one or more processors 120, may enable a user to select an analysis already performed by the server system 112.

The server system 112 may include one or more computing devices such as one or more of 1) a desktop computer, 2) a server, 3) a mainframe, etc. The server system 112 may include one or more processors 144, one more memory devices 148 (e.g., RAM, ROM, FLASH memory, a magnetic disk, an optical disk, a database system, etc.), and a network interface 152 to communicatively couple the server system 112 to the network 108 (and, optionally, another suitable network or communication link for communicating with the user computer 104). At least some of the one or more processors 144, the one or more memory devices 148, and the network interface 152 may be communicatively coupled together via one or more of 1) one or more busses, 2) one or more networks (e.g., a local area network (LAN), a wide area network (WAN), etc.) 3) point-to-point communication links, 4) cords, etc. (not shown).

The one or more memory devices 148 may store an analytical system application 160 that performs a large-scale analysis of content available via the network 108, such as web pages, blogs, social media pages, etc. The analytical system application 160, when executed by the one or more processors 144, may perform an analysis based on a user input received from the user computer 104. For example, the server system 112 may receive text entered by a user in a text box, user selections made using menus, buttons, etc., via a web page generated by the server system 112. Additionally or alternatively, the analytical system application 160, when executed by the one or more processors 144, may perform analyses and then permit a user to select, e.g., via a web page generated by the server system 112, results of the analyses.

The one or more memory devices 148 may also store an interface application 164 (e.g., a web server application) that is configured to exchange information with the user computer 104. For example, the interface application 164, when executed by the one or more processors 144, may generate one or more web pages to permit a user to provide input indicative of an analysis to be performed, a selection of an analysis already performed, etc. Similarly, the interface application 164, when executed by the one or more processors 144, may generate one or more web pages to provide analytical information, generated by the analytical system application 160, to the user computer 104.

The server system 112 may be communicatively coupled to a search engine system 180. For example, the search engine system 180 may generate an index 184 that is utilized for Internet searches, social media page searches, etc., and the analytical system application 160 may utilize the index 184 in performing analyses. For example, the server system 112 may electronically receive the index 184 via the network 108, and the analytical system application 160 may then utilize the index 184. In other embodiments, however, the analytical system application 160 may generate an index similar to the index 184, rather than or in addition to using the index 184 generated by the search engine system 180, and the analytical system application 160 may utilize the index generated by the analytical system application 160 in performing analyses.

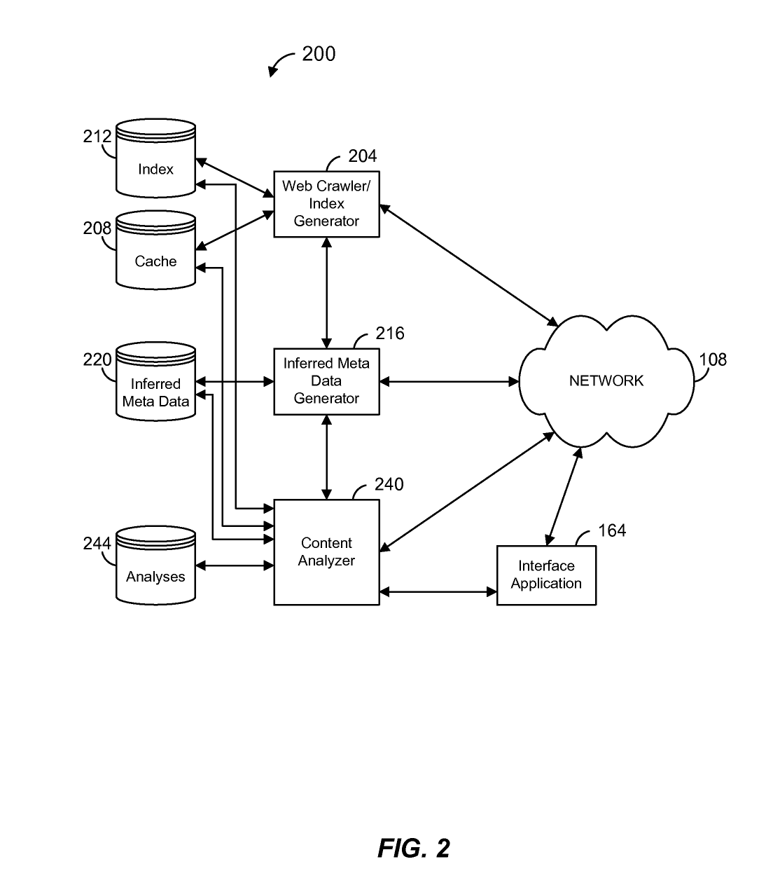

FIG. 2 is a block diagram of an example analysis system 200 for analyzing a large number of documents or files (e.g., web pages, social media pages, etc.) accessible via the network 108 to provide quantitative and/or qualitative information regarding information stored in or related to the documents, files, etc., according to an embodiment. The analysis system 200 may be implemented by the server system 112, in an embodiment, or by another suitable computing system.

The analysis system 200 may include a web crawler/index generator 204 communicatively coupled to the network 108. The web crawler/index generator 204 may include a suitable web crawler configured to retrieve documents, files, etc., accessible via the network 108 (e.g., web pages, social media pages, etc.) in a methodical, automated, and/or orderly manner. At least some retrieved documents, files, etc., and/or at least portions thereof, may be stored in a database 208. The web crawler/index generator 204 may also be configured to generate an index corresponding to the retrieved documents, files, etc. The index may be structured to permit searching for documents, files, etc., using one or more of 1) text included in the documents, files, etc., 2) metadata included in the documents, files, etc., 3) inferred metadata (to be discussed below) corresponding to the documents, files, etc. The generated index may be stored in a database 212.

The analysis system 200 may also include an inferred metadata generator 216, which may be communicatively coupled to the web crawler/index generator 204, and, optionally, to one or both of 1) the cache database 208 and 2) the index database 212. The inferred metadata generator 216 may be configured to infer metadata regarding a document, file, etc., based on one or more of 1) data within the document, file, etc., 2) metadata included in the document, file, etc., 3) data associated with the document, file, etc., but external to the document, file, 4) inferred metadata corresponding to the document and/or to other documents and that was previously determined by the inferred metadata generator 216, etc. The inferred metadata is not explicit metadata in the document, file, etc., but is rather is determined according to an analysis by the inferred metadata generator 216. Examples of inferred metadata corresponding to a document include an author or owner of the document, authorship information (e.g., information about the author or authors of a document if author is anonymous), a location of the author or owner of the document, when the document was created, a category of the document (e.g., part of a personal web site, part of a corporate web site, a blog, a document about a product or service, a contacts page, etc.), a known entity (e.g., known by the analysis system 200 to be a known person, place, or thing as opposed to knowing merely that text matches a keyword) to which the document refers, a topic of the document, how often the document is updated, prerequisite knowledge required to understand the document, etc.

To infer an author and/or owner of a document, the inferred metadata generator 216 may be configured to search for a name after a key word in the document such as “by”, “submitted by”, “posted by”, to identify a person or organization that registered a domain name corresponding to the document, etc. To infer authorship information, the inferred metadata generator 216 may be configured to analyze the complexity of text in the document to infer a reading level of the author, analyze text in the document to determine if the author is a native speaker, if not a native speaker, attempt to identify a country of origin based on errors made, analyze the document and/or information associated with the document (e.g., is it Javascript, was it made with a template builder, is it a hosted page, etc.) to determine a technical sophistication of the author and/or owner, etc. If the author is determined to correspond to a user name, and it is determined that the same user name corresponds to the author of other documents, du-duping techniques can be utilized to determine if the user name corresponds to a single author or multiple authors. If the author is identified by the inferred metadata generator 216, other documents authored by the same author and/or providing information about the author can be analyzed to determine information about the author. For example, a Linked In® page or other suitable social media page of the author can be examined to determine an education level of the author, a profession, an employer, hobbies, etc. As another example, content information of the document and/or other documents authored by or about the author may be utilized to determine political leanings of the author (e.g., right, left, moderate).

To infer a location of the author or owner of the document, the inferred metadata generator 216 may be configured to analyze content of the document (e.g., a contacts page of a web site corresponding to the document), analyze registration information corresponding to a domain name corresponding to the document, etc. Additionally, if an author is identified, other documents created by or providing information about the author may be analyzed to infer a location.

To infer when the document was created, the inferred metadata generator 216 may be configured to analyze content of the document. For example, the inferred metadata generator 216 may be configured to search for a “last updated” date in the document. Additionally, other content information may be analyzed to narrow the creation date to a range. For example, if the document refers to a known product, a known event, another document with a known creation date or date range, etc., such information may be utilized to infer a creation date range. For example, if the document refers to the iPad® tablet computer, a known release date of the iPad® tablet computer may be utilized to determine an earliest date. Similarly, if the document refers to “former president George W. Bush,” this information may be utilized to determine an earliest date. Additionally, if an author is identified, other documents created by or providing information about the author may be analyzed to infer a date of creation. For example, if an age of the author is known, if it is known when the author died, such information may be utilized to determine a date range.

To infer a category of the document (e.g., part of a personal web site, part of a professional web site, a blog, a document about a product or service, a contacts page, etc.), the inferred metadata generator 216 may be configured to analyze content of the document, information about a domain name corresponding to the document, etc.

To infer that a document corresponds to a known entity (e.g., known by the analysis system 200 to be a known person, place, or thing as opposed to knowing merely that text matches a keyword), the inferred metadata generator 216 may be configured to analyze content of the document to search for text that corresponds to the known entity. For example, to determine whether the document corresponds to an entity “New York City” known by the analysis system 200 to be the city of New York in the state of New York, the inferred metadata generator 216 may be configured to search for terms such as “New York,” “NYC,” “Big Apple,” etc.

To infer a topic of the document, the inferred metadata generator 216 may be configured to analyze a title of a document, analyze headings, analyze first sentences in paragraphs of the document, analyze the frequency in which certain words are utilized, identifying words, terms, etc., that correspond to a known entity (e.g., known by the analysis system 200 to be a known person, place, or thing as opposed to knowing merely that text matches a keyword).

To infer how often the document is updated, the inferred metadata generator 216 may be configured to analyze information obtained and/or generated by the web crawler/index generator 204. For example, the web crawler/index generator 204 may store information regarding previous versions of the document and/or the cache 208 may include previous versions of the document, and such information may be utilized to determine how often the document is updated.

To infer prerequisite knowledge required to understand the document, the inferred metadata generator 216 may be configured to analyze content information in the document. For instance, if the document refers to an “L2-norm,” it may be inferred that knowledge of vectors and complex numbers may be required. The inferred metadata generator 216 may be configured to identify in the content references to entities known to the analysis system 200. The analysis system 200 may be configured to recognize or associate with entities knowledge required to understand references to the entity.

The inferred metadata generator 216 may be configured to store inferred metadata in a database 220. Additionally or alternatively, the inferred metadata generator 216 may be configured to store inferred metadata in the index generated by the web crawler/index generator 204.

The analysis system 200 may also include a content analyzer 240, which may be communicatively coupled to one or more of 1) the inferred metadata generator 216, 2) the cache database 208, 3) the index database 212, and/or 4) the inferred metadata database 220. The content analyzer 240 may be configured to analyze documents, files, etc., accessible via the network 108, metadata associated with the documents, files, etc. inferred metadata, etc., and to provide such analyses to requesting devices, such as the user computer 104, via the interface application 164 and via the network 108. In particular, the content analyzer 240 may be configured to generate reports regarding documents, files, etc. For example, the content analyzer 240 may be configured to generate quantitative aspects of human culture (“culture-nomics”) gleaned from analyses of documents, files, etc., available via the World Wide Web, via social networking sites, etc. For example, the content analyzer 240 may be configured to utilize the index 212 and/or the inferred metadata 220 to identify documents relevant to an analysis, and then to perform the analysis based on the identified documents.

For example, an analysis might be “how many web pages relate to philosophy.” The content analyzer 240 may utilize the index 212 and inferred metadata 220 to identify documents related to philosophy, and then determine their quantity. Further analyses may be performed as well to provide more in depth information. For example, the “locations” of the documents may be determined to provide a breakdown of the number of web pages related to philosophy by country, state, etc. Similarly, authorship information may be analyzed to generate information regarding a breakdown of educational backgrounds of the authors of such pages. Authorship information may be determined based on inferred metadata previously generated and/or based on analyses of authorship information gleaned from other documents identified by the content analyzer 240 using the index 212 and/or the inferred metadata 220 and obtained by the content analyzer 240 via the network 108 or via the cache 208, etc. Such further analyses may be generated automatically in response to the originally requested analysis “how many web pages relate to philosophy,” or in response to further specific analyses requests.

As another example, an analysis might be “do people like the iPhone 4S®”. The content analyzer 240 may utilize the index 212 and inferred metadata 220 to identify documents that have a topic “iPhone 4S®”. The content analyzer 240 may be configured to then analyze these documents to determine whether each documents presents, for example, a positive view of the “iPhone 4S®”, an negative view, a neutral view. Then, the content analyzer 240 may be configured to generate a report such as “70% of web pages are positive, 20% are negative, and 10% are neutral”. Further analyses may be performed as well to provide more in depth information. For example, the “locations” of the documents may be determined to provide a breakdown of the positive/negative/neutral ratings by country, state, etc. Similarly, authorship information may be analyzed to generate information regarding a breakdown of positive/negative/neutral ratings by authors' educational background, ages, political leaning, etc. Similarly, inferred metadata may be analyzed to generate information regarding the rate at which postings about the iPhone 4S® are being made, the change in the rate of such postings over time, etc. Such further analyses may be generated automatically in response to the originally requested analysis “do people like the iPhone 4S®,” or in response to further specific analyses requests.

As another example, an analysis might be “pizza places in Boston”. The content analyzer 240 may utilize the index 212 and inferred metadata 220 to identify web pages corresponding to pizza restaurants located in Boston. The content analyzer 240 may be configured to then analyze these documents to determine a number of pizza restaurants in Boston, and to generate a corresponding report. Further analyses may be performed as well to provide more in depth information. For example, the identified web pages may be analyzed to determine hours of operation, and a report that identifies how many and which restaurants are currently open may be generated. As another example, web pages, blogs, etc., that provide opinions regarding the restaurants may be identified, and such documents may be analyzed to determine how many reflect a positive opinion of a restaurant, a negative opinion, etc., and a report that provides such information for each restaurant may be generated.

As another example, an analysis might be “of college X, college Y, and college Z, which have the most graduates working for startups?” The content analyzer 240 may utilize the index 212 and inferred metadata 220 to identify web pages that are authored by or provide information about people who have graduated from the identified colleges. Similarly, the content analyzer 240 may utilize the index 212 and inferred metadata 220 to identify web pages that provide information about where these people work. Then, the content analyzer 240 may analyze information provided in these documents to generate a report providing the requested information.

As another example, an analysis might be “are political bloggers positive about candidacy of candidate X?” The content analyzer 240 may utilize the index 212 and inferred metadata 220 to identify web pages corresponding to political blogs. Then, the content analyzer 240 may analyze content of these blogs to determine whether each writes about candidate X, and if so, whether the blog is positive or negative regarding candidate X. The content analyzer 240 may then utilize such information to generate a report providing the requested information. Further analyses may be performed as well to provide more in depth information. For example, content of the identified blogs, inferred metadata or information obtained from other documents regarding blog authors, etc., may be analyzed to determine whether a political ideology of each blogger (e.g., right, left, moderate), etc., and a report that identifies reaction to candidacy of candidate X broken down by political ideology may be generated. As another example, news-type web pages mentioning candidate X may be identified, and content of such web pages may be analyzed to determine whether the content of each news-type web page is positive, negative, or neutral regarding candidate X, and a report that identifies percentage of news-type web pages that are positive, negative, neutral may be generated.

As another example, an analysis might be “what has person X written?” The analysis system may then analyze documents as described above to identify web pages authored by person X, blogs authored by person X, books written by person X, social media pages corresponding to person X, etc. Thus, the analysis system may be configured to recognize that a person may have multiple web presences, but each corresponds to the same person.

At least some information generated by the content analyzer 240 in performing analyses may be stored as inferred metadata and used for performing subsequent analyses. In some embodiments, the content analyzer 240 may utilize the in performing analyses

The inferred metadata generator 216 and/or the content analyzer 240 may utilize natural language processing (NLP) techniques when generating inferred metadata, analyzing content of documents, etc., in some embodiments.

The inferred metadata generator 216 and/or the content analyzer 240 may utilize image processing techniques when generating inferred metadata, analyzing content of documents, etc., in some embodiments. For example, images in documents can be analyzed to determine whether the image includes a face, if so, how many faces, an ethnicity of a face, color of hair, etc. Such information can be utilized in generating quantitative analyses of documents, files, etc., such as described above. For example, an example report may be “how many pictures of Madonna with dark hair?”, or “how many pictures of two people,” or “of pictures of fortune 500 CEOs, how many are not wearing a tie?” Similarly, the inferred metadata generator 216 and/or the content analyzer 240 may utilize metadata of images in the quantitative analyses and/or to generate inferred metadata. For example, location distribution information from geotags of images on a personal web page or social media page may be utilized to infer a location of the person, or where the person likes to travel, where the person frequents, etc. As another example, a report for “how many pictures of the Willis Tower,” may utilize image geotag information that corresponds to the location of the Willis Tower along with inferred metadata that infers that untagged images are of the Willis Tower.

Thus, the analysis system 200 permits the treatment of the billions of documents available through the Internet, social networking systems, etc., as a data set that can be quantitatively analyzed, and the analysis system 200 is configured to provide such analyses. In some embodiments, at least some analyses may be performed in advance to anticipate analyses that users may request. Additionally or alternatively, analyses are performed in response to user requests.

In some embodiments, the analysis system 200 may be configured to perform initial analyses not in response to user requests, but generally in anticipation of user requests, so that subsequent analyses may be performed more quickly. For example, inferred metadata may be generated ahead of time to enable faster generation of reports in response to user requests. Examples of inferred metadata may include general categorical information such as whether a web page is a personal page or corresponds to an organization such as a company, whether a document includes content corresponding to a known entity, whether a document is a blog, whether a document includes content corresponding to a known commercial product, who is the author, what is a location of the author, etc. In other embodiments, on the other hand, a full analysis is performed in response to a user request. For example, inferred metadata and a deeper analysis that utilizes the inferred metadata may both be generated in response to user requests.

In some embodiments, the analysis system 200 need not include web crawler functionality. Rather, the analysis system 200 may utilize search index information generated by an external search engine. In these embodiments, the index generator 204 may utilize the index information generated by the external search engine and may supplement such information with inferred metadata.

The blocks 204, 216 and 240 of FIG. 2 may be components of the analytical system application 160 of FIG. 1. The blocks 164, 204, 216 and 240 of FIG. 2 may be implemented as software modules executed by one or more processors, hardware modules, or a combination thereof.

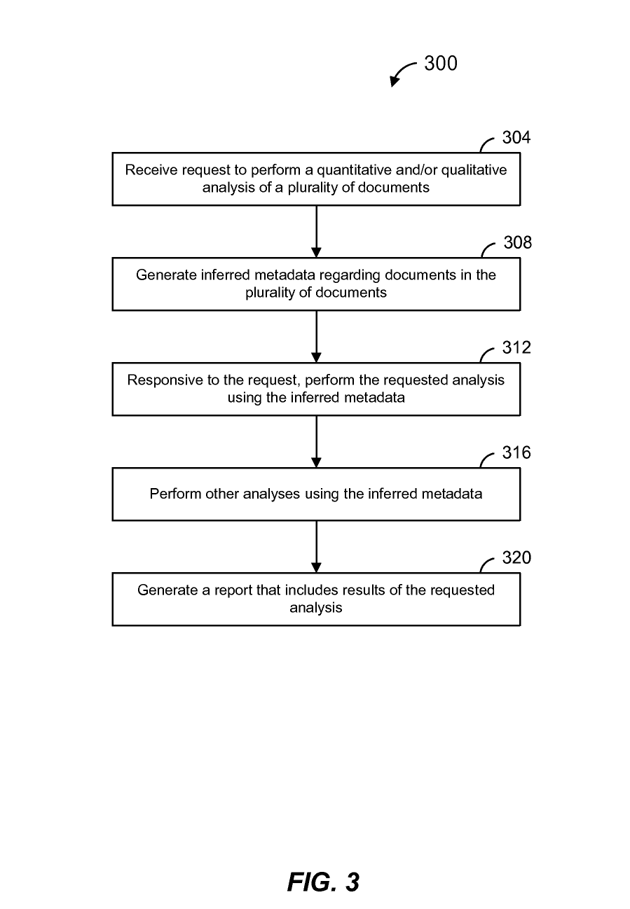

FIG. 3 is a flow diagram of an example method 300 for quantitatively and/or qualitatively analyzing a plurality of documents available on a communication network such as the Internet, an intranet, an extranet, etc., according to an embodiment. The method 300 may be implemented by the system 100 of FIG. 1 and/or the system 200 of FIG. 2, in some embodiments. For example, the method 300 may be implemented by the server system 112, in an embodiment. FIG. 3 is described with reference to FIGS. 1 and 2 for explanatory purposes, but the method 300 may be implemented by other suitable systems in other embodiments.

At block 304, a request to perform a quantitative and/or qualitative analysis of a plurality of documents may be received, where the plurality of documents are available on a communication network. The communication network may be, or include at least portions of, the Internet, an intranet, an extranet, etc. The request may be received via the communication network, in some embodiments. For example, the request may be received by the interface application 164 from a user computer 104 via the network 108. In some embodiments, the request is received via a user interface device such as a keyboard, a touch screen, etc., of or coupled to the server system 112.

At block 308, inferred metadata regarding documents in the plurality of documents are generated. In an embodiment, the inferred metadata is generated at least by (i) using a search engine index that indexes the plurality documents, and (ii) analyzing one or more of (a) contents of documents in the plurality of documents, (b) metadata included in documents in the plurality of documents, (c) data associated with documents in the plurality of documents and external to the documents, (d) previously generated inferred metadata regarding documents in the plurality of documents. In an embodiment, at least some of the inferred metadata is generated responsive to the request received at block 304. In an embodiment, at least some of the inferred metadata is generated prior to receiving the request received at block 304.

Examples of inferred metadata include an author or owner of the document, authorship information (e.g., information about the author or authors of a document if author is anonymous), a location of the author or owner of the document, when the document was created, a category of the document (e.g., part of a personal web site, part of a corporate web site, a blog, a document about a product or service, a contacts page, etc.), a known entity (e.g., known by the analysis system 200 to be a known person, place, or thing as opposed to knowing merely that text matches a keyword) to which the document refers, a topic of the document, how often the document is updated, prerequisite knowledge required to understand the document, etc.

The inferred metadata may be added to a search engine index, in an embodiment. Additionally or alternatively, the inferred metadata may stored in the database 220 separate from the database 212 that stores the search engine index, in an embodiment.

At block 312, the requested analysis is performed using inferred metadata generated at block 308 and responsive to the request received at block 304. In an embodiment, the analysis is performed also using a search engine index.

Block 312 may comprise identifying documents, in the plurality of documents, relevant to the analysis (e.g., using (i) the search engine index, and/or (ii) the inferred metadata), and performing the requested quantitative and/or qualitative analysis on the identified relevant documents, in an embodiment. Block 312 may include analyzing contents of the identified relevant documents, in an embodiment. Block 312 may include performing the requested analysis using results of a previously performed analysis, in an embodiment.

Block 312 may include determining a subset of the identified documents that satisfy a criterion, and determining a quantity of documents in the subset. As an example, a requested analysis might be “do people like the iPhone 4S®?”, and documents that have a topic “iPhone 4S®” may be identified. Then, the identified documents may be analyzed to determine whether each document presents, for example, a positive view of the “iPhone 4S®”, a negative view, or a neutral view, and the numbers of documents with positives views, negative views, and neutral may be determined.

As another example, a requested analysis might be “are political bloggers positive about candidacy of candidate X?”, web pages corresponding to political blogs and that write about candidate X are identified. Then, it is determined whether each blog is positive or negative regarding candidate X, and the numbers of positive blogs and negative blogs may be determined.

At block 316, one or more other analyses related to the requested analysis are performed using inferred metadata generated at block 308. Such other analyses may be determined and generated responsive to the originally requested analysis.

For instance, referring to the “do people like the iPhone 4S®?” example analysis discussed above, the “locations” of the documents may be determined to provide a breakdown of the positive/negative/neutral ratings by country, state, etc. Similarly, authorship information may be analyzed to generate information regarding a breakdown of positive/negative/neutral ratings by authors' educational background, ages, political leaning, etc. Similarly, inferred metadata may be analyzed to generate information regarding the rate at which postings about the iPhone 4S® are being made, the change in the rate of such postings over time, etc. Such further analyses may be generated automatically in response to the originally requested analysis “do people like the iPhone 4S®,” or in response to further specific analyses requests.

Referring to the “are political bloggers positive about candidacy of candidate X?” example analysis discussed above, content of the identified blogs, inferred metadata or information obtained from other documents regarding blog authors, etc., may be analyzed to determine whether a political ideology of each blogger (e.g., right, left, moderate), etc., and to determine reaction to candidacy of candidate X broken down by political ideology. As another example, news-type web pages mentioning candidate X may be identified, and content of such web pages may be analyzed to determine whether the content of each news-type web page is positive, negative, or neutral regarding candidate X, and to determine quantities of news-type web pages that are positive, negative, or neutral.

In some embodiments, block 316 is omitted.

At block 320, a report is generated using results of the analysis performed at block 312 and, optionally, results of the one or more analyses performed at bock 316. The report may be transmitted via the communication network, in some embodiments. For example, the report may be transmitted by the interface application 164 to the user computer 104 via the network 108.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of components, modules, or mechanisms. Modules may constitute either software modules (e.g., code stored on a tangible, non-transitory machine-readable medium (e.g., a memory such as a RAM, ROM, FLASH memory, magnetic disk, optical disk, etc.)) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently or semi-permanently configured (e.g., as a special-purpose processor, such as a programmable logic device (PLD), an application-specific integrated circuit (ASIC), a custom integrated circuit) to perform certain operations. A hardware module may also comprise programmable logic or circuitry (e.g., as encompassed within a general-purpose processor, a special-purpose processor (e.g., a digital signal processor) or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” or the phrase “in an embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Still further, the figures depict embodiments of analysis systems for purposes of illustration only. One skilled in the art will readily recognize from the following discussion that alternative embodiments of the structures and methods illustrated herein may be employed without departing from the principles described herein

Upon reading this disclosure, those of skill in the art will appreciate still additional alternative structural and functional designs for a system and a process for identifying terminal road segments through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope of the invention.

What is claimed is:

1. A method for quantitatively and/or qualitatively analyzing a plurality of documents available on a communication network, comprising:
generating, at one or more computing devices, inferred metadata regarding documents in the plurality of documents available on the communication network at least by (i) using a search engine index that indexes the plurality documents, and (ii) analyzing one or more of (a) contents of documents in the plurality of documents, (b) metadata included in documents in the plurality of documents, (c) data associated with documents in the plurality of documents and external to the documents, (d) previously generated inferred metadata regarding documents in the plurality of documents;
responsive to a request to perform a quantitative and/or qualitative analysis of the plurality of documents, performing, at one or more computing devices, the requested analysis using (i) the search engine index, and (ii) the inferred metadata; and
generating, at one or more computing devices, a report that includes results of the requested analysis.

2. A method according to claim 1, wherein at least some of the inferred metadata is generated responsive to the request to perform the analysis.

3. A method according to claim 1, wherein at least some of the inferred metadata is generated prior to receiving the request to perform the analysis.

4. A method according to claim 1, wherein generating the inferred metadata comprises determining for each document in at least a subset of the documents at least one of (i) a topic of the document, and (ii) and a category of the document.

5. A method according to claim 4, wherein determining a topic of a document comprises at least one of (i) analyzing a title in the document, (ii) analyzing headings in the document, (iii) analyzing first sentences in paragraphs of the document, (iv) analyzing the frequency in which words are utilized in the document, and (v) identifying words that correspond to an entity known to an analysis system.

6. A method according to claim 4, wherein determining a category of a document comprises determining that the document is at least one of (i) a page of a personal web site, (ii) a page of a professional web site, (iii) a blog, (iv) concerning a product or service, and (v) a contacts page.

7. A method according to claim 1, wherein performing the requested analysis comprises:
identifying documents, in the plurality of documents, relevant to the analysis using (i) the search engine index, and (ii) the inferred metadata; and
performing the requested quantitative and/or qualitative analysis on the identified relevant documents.

8. A method according to claim 7, wherein performing the requested quantitative and/or qualitative analysis on the identified relevant documents comprises analyzing contents of the identified relevant documents.

9. A method according to claim 7, wherein performing the requested quantitative and/or qualitative analysis on the identified relevant documents comprises:
determining a subset of the identified documents that satisfy a criterion; and
determining a quantity of documents in the subset.

10. A method according to claim 1, wherein performing the requested analysis comprises:
performing the requested analysis using results of a previously performed analysis.

11. A method according to claim 1, further comprising generating the search engine index.

12. A method according to claim 1, further comprising adding inferred metadata to the search engine index.

13. A method according to claim 1, wherein:
the communication network includes the Internet; and
the search engine index is an Internet search engine index; and
analyzing contents of documents in the plurality of documents comprises at least one of (i) obtaining at least a first subset of the documents via the Internet, and (ii) obtaining at least a second subset of the documents via a cache generated by the Internet search engine.

14. A system for quantitatively and/or qualitatively analyzing a plurality of documents available on a communication network, the system comprising:
one or more computing devices configured to:
generate inferred metadata regarding documents in the plurality of documents available on the communication network at least by (i) using a search engine index that indexes the plurality documents, and (ii) analyzing one or more of (a) contents of documents in the plurality of documents, (b) metadata included in documents in the plurality of documents, (c) data associated with documents in the plurality of documents and external to the documents, (d) previously generated inferred metadata regarding documents in the plurality of documents,
perform, responsive to a request to perform a quantitative and/or qualitative analysis of the plurality of documents, the requested analysis using (i) the search engine index, and (ii) the inferred metadata, and
generate a report that includes results of the requested analysis.

15. A system according to claim 14, wherein the one or more computing devices are configured to generate at least some of the inferred metadata responsive to the request to perform the analysis.

16. A system according to claim 14, wherein the one or more computing devices are configured to generate at least some of the inferred metadata prior to receiving the request to perform the analysis.

17. A system according to claim 14, wherein the one or more computing devices are configured to generate inferred metadata that includes, for each document in at least a subset of the documents, at least one of (i) a topic of the document, and (ii) and a category of the document.

18. A system according to claim 17, wherein the one or more computing devices are configured to determine a topic of a document at least by one or more of (i) analyzing a title in the document, (ii) analyzing headings in the document, (iii) analyzing first sentences in paragraphs of the document, (iv) analyzing the frequency in which words are utilized in the document, and (v) identifying words that correspond to an entity known to an analysis system.

19. A system according to claim 17, wherein the one or more computing devices are configured to determine a category of a document at least by determining that the document is at least one of (i) a page of a personal web site, (ii) a page of a professional web site, (iii) a blog, (iv) concerning a product or service, and (v) a contacts page.

20. A system according to claim 14, wherein the one or more computing devices are configured to perform the requested analysis at least by:
identifying documents, in the plurality of documents, relevant to the analysis using (i) the search engine index, and (ii) the inferred metadata; and
performing the requested quantitative and/or qualitative analysis on the identified relevant documents.

21. A system according to claim 20, wherein the one or more computing devices are configured to perform the requested quantitative and/or qualitative analysis on the identified relevant documents at least by analyzing contents of the identified relevant documents.

22. A system according to claim 20, wherein the one or more computing devices are configured to perform the requested quantitative and/or qualitative analysis on the identified relevant documents at least by:
determining a subset of the identified documents that satisfy a criterion; and
determining a quantity of documents in the subset.

23. A system according to claim 14, wherein the one or more computing devices are configured to perform the requested analysis at least by:
performing the requested analysis using results of a previously performed analysis.

24. A system according to claim 14, wherein the one or more computing devices are configured to generate the search engine index.

25. A system according to claim 14, wherein the one or more computing devices are configured to add inferred metadata to the search engine index.

26. A system according to claim 14, wherein:
the communication network includes the Internet; and
the search engine index is an Internet search engine index; and
the one or more computing devices are configured to analyze contents of documents in the plurality of documents at least by one or both of (i) obtaining at least a first subset of the documents via the Internet, and (ii) obtaining at least a second subset of the documents via a cache generated by the Internet search engine.

27. A system according to claim 14, further comprising a database to store the inferred metadata.

28. A system according to claim 27, wherein the database also stores the search engine index.

29. A tangible, non-transitory, computer readable medium that stores machine readable instructions that, when executed by one or more computing devices, cause the one or more computing devices to:
generate inferred metadata regarding documents in the plurality of documents available on the communication network at least by (i) using a search engine index that indexes the plurality documents, and (ii) analyzing one or more of (a) contents of documents in the plurality of documents, (b) metadata included in documents in the plurality of documents, (c) data associated with documents in the plurality of documents and external to the documents, (d) previously generated inferred metadata regarding documents in the plurality of documents;
responsive to a request to perform a quantitative and/or qualitative analysis of the plurality of documents, perform the requested analysis using (i) the search engine index, and (ii) the inferred metadata; and
generate a report that includes results of the requested analysis.
